(19) United States
(12) Patent Application Publication
(10) Pub. No.: US 2021/0142217 A1
(43) Pub. Date: May 13, 2021

(54) MACHINE-LEARNING AND RULE-BASED SYSTEM AND METHOD FOR EVALUATING USER DATA AND GENERATING A STRATEGY TO ACHIEVE A DESIRED OUTCOME

(71) Applicants: John VALLINE, Dallas, TX (US); Karl SINGER, Dallas, TX (US)

(72) Inventors: John VALLINE, Dallas, TX (US); Karl SINGER, Dallas, TX (US)

(21) Appl. No.: 17/092,198

(22) Filed: Nov. 6, 2020

Related U.S. Application Data
(60) Provisional application No. 62/932,283, filed on Nov. 7, 2019.

(51) Int. Cl. G06N 20/00; G06F 16/245

(52) U.S. Cl. CPC G06N 20/00; G06F 16/245

(57) ABSTRACT

Machine-Learning and Rule-Based System and Method for Evaluating User Data and Generating a Strategy to Achieve a Desired Outcome. For example, one embodiment of a system comprises: a client portal for connecting computing devices to the system; a data collection engine to execute a tree-based script to collect data from a user of the client, the data relevant to one or more services provided by the system; an analysis engine including a first machine learning component to analyze the collected data in view of a desired outcome for the user, the analysis engine to generate results of the analysis including one or more problems for the user to resolve; a recommendation engine including a second machine learning component to evaluate the results generated by the analysis engine and identify options and/or recommendations to resolve the one or more problems; and a client advisor to communicate one or more of the options and/or recommendations to the user over a digital electronic data channel.

### CROSS REFERENCE TO RELATED

This application claims the benefit of U.S. Provisional Application Ser. No. 62/932,283, which was filed on Nov. 7, 2019, all of which is herein incorporated by reference.

### BACKGROUND

### Field of the Invention

This invention relates generally to the field of computer processors and software. More particularly, the invention relates to a machine-learning and rule-based system and method for evaluating user data and generating a strategy for a desired outcome.

### Description of the Related Art

Machine learning (ML) systems are implemented with computer systems executing algorithms and statistical models to perform specified tasks without using explicit instructions, relying instead on patterns and inference instead. Machine learning processes typically construct a model based on “training data” in order to make predictions or decisions without being explicitly programmed to perform the task. For example, a machine learning engine for detecting spam may be trained by providing it with a feature set related to email messages (e.g., email message size, keywords, attachment file types, etc) and having it evaluate a training corpus of messages which includes spam and legitimate messages. Based on the evaluation, the machine learning engine constructs and/or updates the model which may include weights assigned to the various email features.

In addition to “supervised” machine learning systems such as described above, “unsupervised” machine learning systems evaluate a set of data that includes only inputs, and identifies structures in the data (e.g., grouping or clustering of data points). In contrast to the above email example, unsupervised learning algorithms learn from test data that has not been labeled, classified or categorized.

### BRIEF DESCRIPTION OF THE DRAWINGS

A better understanding of the present invention can be obtained from the following detailed description in conjunction with the following drawings, in which:

FIG. 1 illustrates one embodiment of a rule-based cloud service;

FIG. 2 illustrates one embodiment of a machine-learning Cloud service;

FIG. 3 illustrates additional details of a machine-learning Cloud service;

FIG. 4 illustrates training of a machine learning engine performed in one embodiment of the invention; and

FIG. 5 illustrates a method in accordance with one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

Embodiments of the invention include a Cloud-based system with a targeted data collection engine to collect user data related to a particular discipline, an analysis engine to perform machine learning and/or a dynamically configurable rule-based analysis to provide a set of results. In one implementation, the set of results are further evaluated by a machine-learning and/or rule-based recommendation engine in view of user-specified preferences or other variables to generate one or more recommendations related to a desired outcome. Furthermore, one embodiment of the invention includes an enhanced support channel to provide the end user with a heightened level of support to review options and take steps to achieve a desired outcome.

FIG. 1 illustrates one embodiment of a Cloud service architecture 110 in which a client 101 (e.g., a user of a computer or mobile device) connects to the cloud service 110 via a client portal 104. By way of example, the client portal 104 may include a Web server (e.g., for clients connecting with a browser) or network application interface (e.g., for clients connecting via an app) which provides the client 101 with the ability to input data to the cloud service 110 and receive results (e.g., a Web page or application data structure displaying results and data entry fields for entering data and).

In one embodiment, the client portal 104 authenticates registered users via a client database 106 which stores user account data including authentication data. For example, in order to access all of the features of the cloud service 110, client 101 may be required to register with the cloud service 110, providing information such as an email address and password. Once registered, the client portal will access the client database 106 to authenticate the client 101 on each login attempt.

After connecting via the client portal, a data collection engine 105 may execute a tree-based script 107 to determine a user's intentions and collect relevant data needed to generate recommendations and/or options as described herein. In one embodiment, the data collection engine 105 specifies the data to be collected in accordance with the tree-based script 107 to the client portal which generates a Web page or app-based data structure rendered on the client 101.

In one embodiment, as the user enters data for each successive portion of the script 107, the data collection engine 105 stores the data in an analysis database 112 so that the data will be available the next time the client 101 connects to the cloud service 110. Each time a round of data collection is complete, an analysis engine 111 analyzes the data to generate a set of results. In one embodiment, the results include a range of options within which the recommendation engine 114 makes its recommendations.

As illustrated in FIG. 2, in one embodiment, all or a portion of the analysis is performed at different stages of processing by machine learning engines 213, 215. For example, the machine learning engine 213 of the analysis engine learns from historical data collected from prior users to more precisely render results for the current user. The machine-learning engine 213 may be trained using training data sets comprising data collected from prior clients 101 and other pertinent data collected in view of the services provided by the cloud service 110. The machine learning model weights are stored within a database 220 and may be periodically or continually updated as new results become available. In one embodiment, the analysis engine 111 initially performs a rule-based analysis based on a set of business rules specified by a programmer until data has been collected for a sufficient number of clients to adequately train the machine learning engine 213. At this point the analysis engine 111 may rely exclusively on the machine learning engine 213 or may combine results from the machine learning engine 213 and its own rule-based results to render the final results.

FIG. 4 illustrates an example a training corpus 400 from which feature detection logic 401 detects features as specified by a feature set. In one embodiment, the training corpus 400 comprises data sets collected from previous users of the cloud service 110. A machine learning engine 402 analyzes the features detected by the feature detection logic 401 in view of a user-specified categorization of the training corpus data to generate a machine learning model which may include weights for each of the detected features. The categorizations provided to the machine-learning engine 402 are related to the services provided by the cloud service 110. For example, for a cloud service 110 which evaluates a user's options when purchasing a home and provides recommendations/options based on a desired outcome, the categorizations may include data sets associated with qualified users and data sets associated with unqualified users. In the latter case, subcategories may include those users who ultimately became qualified by taking recommended steps and the specific steps taken by those users which resulted in the qualification. Another subcategory may include data sets from users who never qualified. The goal of this training is to train the machine learning engine 402 to learn from past mistakes and potentially identify different courses of action. Of course, the foregoing example is provided merely for the purpose of illustration. The underlying principles of the invention are not limited to this specific implementation.

Regardless of how the data is collected, in one implementation, a recommendation engine 114 evaluates and refines the results for presentation to the client 101 as a set of options and/or recommendations. For example, the analysis engine 111 may generate raw data for a wide range of different variables related to the desired outcome, which the recommendation engine 114 uses to generate and present a more narrowly-tailored set of recommendations and/or options to be presented to the client 101 via a client portal 104. In one embodiment, the recommendation engine 114 may also request additional data from the client 101, resulting in another round of analysis and recommendations.

As illustrated, the recommendation engine 114 may also include a machine learning engine 215 trained based on existing data related to historical recommendations and/or options provided to clients and the final outcomes associated with those recommendations and/or options. As previously described with respect to the analysis engine 111, the recommendation engine 114 may initially be implemented as a rule-based engine and the machine-learning engine 215 component may be activated or partially activated once a sufficient amount of data has been collected and used for training. The recommendation engine 114 may then rely on a combination of the machine-learning engine 215 and its rule-based analysis or may rely exclusively on the machine-learning engine 215. As mentioned, the machine learning model weights and associated data are stored and continually updated in a database 220.

In some instances a client advisor 113 may be triggered to provide a heightened level of client interaction including supplemental data collection, analysis, and/or evaluation of recommendations. In one embodiment, an artificial intelligence (AI) engine 223 may process the options and/or recommendations generated by the recommendation engine 114 and provide supplemental assistance to the client 101. For example, if the user can achieve a desired outcome in a variety of ways, the client advisor 113 may advise the client 101 of the path to the outcome which can be traversed in the shortest amount of time and/or with the least effort.

In one implementation, the AI engine 223 may request additional information from the client 101 via the client portal 104 and may connect with the client 101 via alternate communication channels. For example, the AI engine may include logic to call the client 101 via a voice connection and have a conversation with the client 101 to convey information and collect new data. The AI engine 223 may use a text-to-speech synthesis module to ask questions and convey information and may use a speech-to-text or other interactive voice response (IVR) implementation to collect and record additional data.

In some implementations, it is expected that the client 101 will connect to the cloud service 110 several times to achieve the final result. Each time the client 101 connects, a new round of data collection is performed by the data collection engine 105 (e.g., based on different branches of the tree-based script) followed by the generation of potentially new recommendations and/or options. In each round of interaction, the various machine learning engines 213, 215 and AI engine 223 may perform their respective operations more precisely based on the data collected from prior rounds. In one embodiment, once a final result is achieved, the final set of data associated with the client 101 is stored within the analysis database 112 and/or machine learning model database 220.

As illustrated in FIG. 3, the cloud service 110 may connect with one or more third party cloud service providers 301-302 to collect additional data related to the transaction with the client 101 and/or to redirect the client 101. For example, in an implementation in which cloud service 110 assists the user through the process of acquiring a mortgage on a home for the first time, the third party service 301 may be a bank which will qualify the user for the mortgage 301 and third party service 302 may be a real estate agent service. In one particular implementation, the client 101 is only directed to these services when the cloud service 110 determines that the client 101 has met specified qualification requirements.

To illustrate the capabilities of the various system components, a specific example of data collection, analysis, and recommendations will now be provided. It should be noted, however, that the underlying principles of the invention are not limited to these specific details/implementations.

In this specific implementation, the Cloud-based system is configured to guide a first-time home buyer through the process of purchasing a new home. The data collection engine 105 of this embodiment targets data collection at the specific financial, credit, employment and marital status information relevant to acquiring a mortgage.

In one embodiment, the data collection engine 105 asks the client 101 to specify the names of those individuals who will be on the loan. The selectable options may include “only me”, “spouse and me”, and “other and me.” In one embodiment, selecting one of these options this will cause a different branch of the tree-based script 107 to be traversed for the remaining queries (i.e., to collect data for just the user or for the user and one or more other users).

In one embodiment, each branch in the script 107 will then instruct the data collection engine 105 to collect the desired move date and lease expiration date (if one or more of the users are renting). In addition, the data collection engine 105 will request the user's desired monthly payment, the type of loan desired (if known), financial data, credit data, employment data, current lease data (if renting), and monthly expense data.

In one embodiment, the desired monthly payment is used by the analysis engine 111 and/or recommendation engine 114 to identify the value of the home that the user can purchase and/or the loan that the user may expect to receive, factoring in all other variables including property tax, insurance, lease termination penalties, and other common expenses associated with home ownership.

The type of loan may be specified by the user in response to a query from the data collection engine 105 or may be suggested by the recommendation engine 114 and/or client advisor 113 after all user data has been collected and evaluated. Different types of loans require different down payment percentages, minimum credit scores, debt-to-income ratios, and potentially other variables. Examples include FHA loans, conventional loans, veterans (VA) loans, and USDA loans. Selecting a particular type of loan, may cause the data collection engine 105 to traverse down a new branch of the tree-based script 107.

The financial data collected for each user may include sources of cash to be used for a down payment including checking accounts, savings accounts and retirement accounts (e.g., 401(k) accounts). The data collection engine 105 may also query each user for existing loans (e.g., car loans, student loans, etc) or other debts (e.g., credit card balances), monthly or yearly income, past income tax payments, monthly expenses, and other financial assets (e.g., stocks, bonds, etc). In one embodiment, each user is specifically asked if they have the ability to document all income, whether this income has decreased over the past year (or other timeframe), and whether they receive a W2. With respect to taxes, the data collection engine 105 may specifically ask the user whether they filed tax returns for the last 2 years, whether they have filed for the present year, and whether they claim unreimbursed expenses.

In one embodiment, the data collection engine 105 may ask each user to perform a credit check and provide the results (e.g., running a free credit check via Experian, TransUnion and/or Equifax, or via a third party service). Alternatively, the data collection engine 105 may ask the user a series of questions designed to estimate the user's credit score such as any late payments, collections, charge-offs, judgments, short sales, bankruptcy declarations, foreclosures, or tax liens within the past 24 months. If applicable, the user may also enter a co-borrower's credit score. In another embodiment, the data collection engine 105 requests the user's social security number and runs the credit score on behalf of the user, connecting to one or more of the credit services and providing the social security number (e.g., represented as third party services 301-302 in FIG. 3).

In one embodiment, with respect to employment, the data collection engine 105 may query as to whether there have been job gaps over the last 24 months (or other time period), whether the user can document the last 2 years of work history (or longer), and whether the user has changed careers in the last 2 years (or longer).

With respect to a current lease, the data collection engine 105 may request the user's lease expiration date which may be used by the recommendation engine 114 and/or advisor 113, either by adding the cost of breaking the lease to the closing costs of a home or recommending a course of action to acquire a mortgage/home at the time the lease has ended. In addition, the user may be asked for the ability to show a two year rental history, current rent payment (and whether these can be documented), and whether the user currently lives with any co-borrowers.

One embodiment of the data collection engine 105 queries the user for any additional monthly expenses including, but not limited to, alimony payments and child support. Monthly payments for any outstanding loans and credit card balances may also be requested. One embodiment of the data collection engine 105 collects specific data related to student loans including whether any of the user's loans are in default or have been deferred and whether the user has consolidated their student loans (in addition to requesting the total balance and/or monthly payments).

In one embodiment, the user may log into the client portal 104 multiple times to provide the required data, which is stored in the analysis database 112. Once all of the data has been collected, the analysis engine 111 generates results and the recommendation engine 114 uses this data to provide options and/or recommendations. The client advisor 113 then conveys the options/recommendations to the user, potentially supplementing the options/recommendations in accordance with its AI engine 223.

In one embodiment, the each of the different types of loans mentioned above requires a different percentage for a down-payment, different target debt-to-income ratios, and different minimum credit scores. For example, a conventional loan may require a 5% down payment, a target debt-to-income ratio of 43%, and a minimum credit score of 630. If the user is seeking such a loan, then the analysis engine 111 may determine the target debt-to-income ratio by adding the user's total monthly income by the desired payment and dividing the sum by the user's total monthly expenses. It will then determine, based on relevant portions of the data collected by the data collection engine 105, whether the user qualifies for a particular mortgage. If not, it will generate results indicating one or more of: the shortfall in down payment amount, shortfall in target debt to income ratio, and/or shortfall in credit score.

In this example, the recommendation engine 114 generates a set of options and/or recommendations to address the reasons why the user does not currently qualify for the mortgage. The client advisor 113 presents and/or otherwise communicates the options and/or recommendations to the user, potentially supplementing these with additional suggestions.

For example, if the user can only provide a 4% down-payment for a mortgage that requires 5%, then the client advisor 113 highlights the shortfall amount and may also provide an indication of the mortgage type and size that the user will qualify for. It may also provide options for identifying a money source to make up the shortfall. For example, if the user has a 401(k) account, the client advisor 113 may identify this account as a potential source to make up the 1% shortfall in the down-payment. In addition, in one embodiment, the client advisor 113 provides ways to reduce the user's out-of-pocket expenses for the purchase. This may include a seller contribution (i.e., where the seller contributes money towards the closing costs) and/or a lender contribution (e.g., where a particular lender with a relationship with the cloud service 110 agrees to contribute towards closing costs to enable the user to qualify. It may then present a savings analysis to the user comprising one or more of the above sources.

In a case where the user's credit score is lower than the minimum required, the client advisor 113 may itemize steps the user can take to increase his/her credit score to reach the minimum value. This may include, for example, not opening any new accounts and paying existing accounts on time for a specified period of time. In one embodiment, the client advisor 113 will instruct the user to acquire a detailed credit report to determine if there are errors which have decreased the user's credit rating. If so, these can be removed from the credit report to increase the user's credit rating. The user may also be instructed to pay down one or more balances, to pay more than once per month, and/or to request an increase in a credit limit.

In cases where the reason that the user does not qualify is because a co-borrower fails to qualify for one or more of the above reasons, the client advisor 113 may suggest alternate courses of action to allow the user to make the purchase without the co-borrower.

The client advisor 113 may communicate with the user via Web pages or application-specific data formats (depending on the client 101 being used). In addition, the AI engine 223 may include access to other forms of communication such as text/chat communication channels and voice communication. For example, AI engines have been developed which can carry on a conversation with the user to convey information and collect new data. As mentioned, the AI engine 223 may include or access a text-to-speech synthesis module to ask questions and convey information and may use a speech-to-text or other interactive voice response (IVR) implementation to collect and record additional data.

As mentioned, the user may connect via the client portal 104 a number of times to enter new data (e.g., when recommendations have been followed) and receive new options/recommendations until the user qualifies for the loan. Significantly, this embodiment of the invention allows the user to self-qualify via the cloud service 110 as described herein prior to interacting with a loan officer at a bank. Once the analysis engine 111 determines that the user qualifies, the cloud service 110 may (upon receiving user permission) refer the user to a particular loan officer or bank (e.g., represented by third party service 301 in FIG. 3) and a realtor (represented by third party service 302). The client advisor 113 may continue to be available to the user up through the process of the closing on a home, to provide options/recommendations at each stage of the process.

A method in accordance with one embodiment is illustrated in FIG. 5. The method may be implemented within the context of the above architectures, but is not limited to any particular architecture.

At 501, a current rule set is applied and/or one or more machine learning engines are trained using a training corpus (as described above). At 502, a new/additional client query is received indicating a desired result (e.g., qualification for a loan). At 503, a data collection routine (e.g., a script) is executed and, at 504, the collected data is analyzed in view of the current rule set and/or using one of the machine learning engines to generate a set of results.

At 505, the results are evaluated with a current rule set and/or machine learning engine to generate recommendations and/or options. At 506, the recommendations and/or options may be formatted and communicated to the client. If the client follows the recommendations/options but the desired outcome has still not been reached, determined at 507, then the client may reconnect and provide additional data (including the results of the recommendations/options), resulting in another set of recommendations. Once the desired outcome is reached, an indication of the final outcome is received at 508 and additional training of the machine learning engines may be performed using the data associated with the final outcome.

In the foregoing specification, the embodiments of invention have been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A system comprising:
a client portal for connecting computing devices to the system;
a data collection engine to execute a tree-based script to collect data from a user of the client, the data relevant to one or more services provided by the system;
an analysis engine including a first machine learning component to analyze the collected data in view of a desired outcome for the user, the analysis engine to generate results of the analysis including one or more problems for the user to resolve;
a recommendation engine including a second machine learning component to evaluate the results generated by the analysis engine and identify options and/or recommendations to resolve the one or more problems; and
a client advisor to communicate one or more of the options and/or recommendations to the user over a digital electronic data channel.

2. The system of claim 1 further comprising:
a first machine learning model database comprising weights associated with a first set of features of the collected data, the first machine learning component of the analysis engine to use the weights to generate the results.

3. The system of claim 2 further comprising:
a second machine learning model database comprising weights associated with a second set of features related to prior options and/or recommendations provided to prior users, the second machine learning component to generate the options and/or recommendations for the user based on the weights.

4. The system of claim 1 wherein the client advisor comprises an artificial intelligence (AI) engine to communicate with the client using a variety of communication channels.
